(19) United States
(12) Patent Application Publication
(10) Pub. No.: US 2022/0152869 A1
(43) Pub. Date: May 19, 2022

(54) A METHOD OF MAKING MOLDED PARTS HAVING SMOOTH SURFACE AND MOLDED PARTS MADE THEREOF

(71) Applicant: Construction Research & Technology GmbH, Trostberg (DE)

(72) Inventors: Hiromitsu KOYAMA, Kanagawa (JP); Jing CUI, Chigasaki-shi (JP); Siddharth ROY CHOWDHURY, Chigasaki-shi (JP); Xue Wu RAO, Shanghai (CN)

(21) Appl. No.: 17/423,367

(22) PCT Filed: Jan. 13, 2020
(86) PCT No.: PCT/EP2020/050645

§ 371 Date: Jul. 15, 2021

(30) Foreign Application Priority Data
Jan. 15, 2019 (CN) PCT/CN2019/071750

(51) Int. Cl. B28B 7/38; B28B 1/14; B28B 7/36; C09D 5/00; C09D 163/00; C09D 175/04

(52) U.S. Cl. CPC B28B 7/384; B28B 1/14; C09D 175/04; C09D 5/002; C09D 163/00; B28B 7/364

(57) ABSTRACT

The invention relates to a method of making parts of construction materials by using a mold coated with multiple resin-based layers comprising at least an epoxy resin-based primer and a polyurethane resin-based demolding layer, wherein the mold can be used for multiple cycles after curing and demolding. The invention also relates to the resin-coated mold and the cured parts of construction materials having smooth surface made thereof.

### TECHNICAL FIELD

The present invention relates to a method of making a molded object in the construction field. More specifically, the present invention relates to a method of making molded parts of construction materials by using a mold coated with multiple resin-based layers, and to molded parts of construction materials made thereof.

### BACKGROUND

It is known that construction materials, such as paste, mortar or concrete can be cast in a mold and subsequently demolded after curing to form molded parts. Demolding agents are commonly used to facilitate the demolding process. When using conventional demolding agents, for example, mineral oil or plant oil, workers need to pre-treat the mold by brushing the mineral oil or plant oil on the surface of the mold each time before the construction material, e.g. concrete is added to the cavities of the mold. After the concrete block is cured and removed from the mold, the mold is post-treated by removing remains of the mineral oil or plant oil and sometimes even concrete residuals on the mold surface, washing and drying. Therefore, each cycle of making molded parts comprises the following steps: pre-treatment, curing, demolding, and post-treatment.

Several technical problems are present in such practices. One flaw is the surface finish of the molded parts, e.g. concrete parts. Air voids are frequently found on the surface of such concrete parts and additional surface repair is required after demolding, which will increase project time, labor and cost. Another flaw is the repeated and elaborate pre-treatment and post-treatment of the mold in each cycle. Workers have to spend more time and more materials in preparing the mold, which also increases the project time, labor and cost. Such problems are common for construction materials using cement as the binder (e.g. cement mortar or cement concrete).

FIG. 5

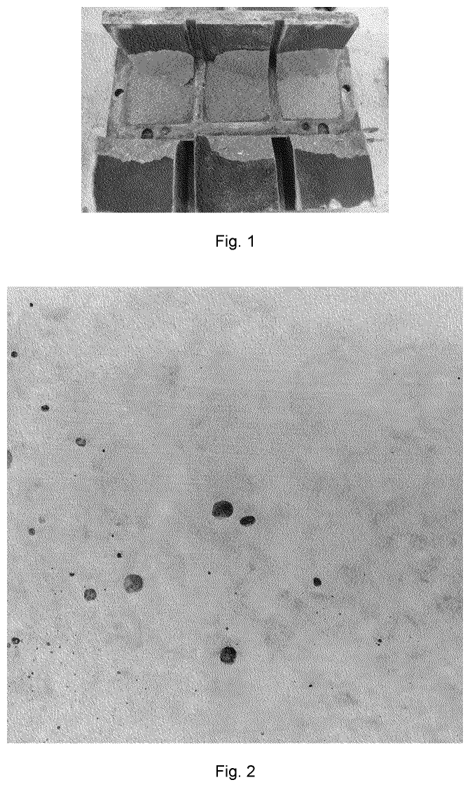

The problem of demolding by using above-mentioned conventional demolding agents is even more prominent for geopolymer-containing construction materials, e.g. geopolymer mortar or geopolymer concrete, which replace cement with geopolymer as the binding material. Geopolymer is an inorganic binder system based on reactive, water-insoluble compounds based on SiO₂ in conjunction with Al₂O₃, which cure in an aqueous-alkali medium and form alumino-silicate based inorganic polymer with amorphous network. Geopolymer is usually produced by adding alkali activating agents to latent hydraulic and/or pozzolanic materials containing aluminosilicate minerals such as metakaolin, coal fly ash and/or furnace slag. The mixture hardens after polycondensation or geopolymerization reaction instead of hydration reaction as in ordinary cement. In geopolymer mortar or concrete, geopolymer binds aggregates (e.g. sand and/or gravel), and other materials, thus forming geopolymer mortar or geopolymer concrete. Geopolymer paste, mortar or concrete normally shows strong adhesion with the mold upon curing. Traditional demolding agents such as mineral oil, diesel oil, or vegetable oil cannot solve the problem of attachment of geopolymer-containing construction materials, e.g. geopolymer concrete, to the mold, leading to a very challenging demolding process, low quality of geopolymer concrete surface finish and increased cost in cleaning or maintenance of the mold and in repairing geopolymer concrete surface. As shown in FIG. 1, chunks of geopolymer concrete residue are left on the surface of the mold when mineral oil is used as demolding agent. Therefore, it's also a purpose of the present invention to produce geopolymer-containing parts with good demolding result, such as desired surface finish and an easy-to-clean and reusable mold.

It is, therefore, advantageous to provide a method of making molded parts of construction materials without abovementioned flaws. The purpose of the present invention is to provide a mold, a method of making a mold and a method of making molded parts of construction materials having improved surface finish by using a mold that can be used for multiple cycles without complex pre-treatment and post-treatment in each cycle.

### SUMMARY OF THE PRESENT INVENTION

One object of the invention is to provide a mold suitable for making molded parts of construction materials and a method of preparing such a mold. Another object of the invention is to provide a method of making molded parts of construction materials having improved surface finish. Yet another object of the invention is to provide a method of making molded parts by using a mold that can be used for multiple cycles without complex pre-treatment and post-treatment of the mold in each cycle. The molded parts made thereof are expected to have fewer air voids on the surface and require less repair after demolding.

It has been found by the inventors that the above objects can be solved by preparing a mold for molding construction materials characterized in that the mold is coated with multiple resin-based layers comprising at least a first epoxy resin-based primer layer and a second polyurethane resin-based demolding layer and by using such a mold to mold construction materials. Preferably, the primer is in direct contact with the substrate of the mold and is epoxy resin-based, while the demolding layer (when used for (de)molding construction materials) is in direct contact with the construction materials to be demolded and is polyurethane resin-based.

In one aspect, the invention relates to a mold for molding construction materials coated with multiple resin-based layers comprising at least a first epoxy resin-based primer layer and a second polyurethane resin-based demolding layer and to use of such a mold in making molded parts of construction materials having smooth surface.

In a further aspect, the invention relates to a method for molding construction materials comprising the steps of:

I) adding construction materials into a mold coated with multiple resin-based layers comprising at least a first epoxy resin-based primer layer and a second polyurethane resin-based demolding layer;

II) curing the construction materials to form cured parts of construction materials; and

III) demolding the cured parts of construction materials from the mold, optionally, wherein step I) to III) can be repeated for not less than twice.

In a further aspect, the invention relates to the application of the method and to molded parts of construction materials having smooth surface made thereof.

### DETAILED DESCRIPTION OF THE PRESENT INVENTION

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

As used herein, the term “about” is understood to refer to a range of numbers that a person of skill in the art would consider equivalent to the recited value in the context of achieving the same function or result.

As used herein, the term “mold” refers to a frame or a container used in the process of manufacturing shaped objects by shaping raw materials therein. A mold can be a unibody structure or be made of multiple pieces that come together to form cavities of a certain pattern in the mold.

As used herein, the term “molded” refers to the result of an object made by using a mold. By way of example, a construction material is filled in the mold and later hardens or cures inside the mold, adopts its shape, and finally releases when the mold disassembles.

As used herein, the term “smooth” as in “smooth surface” refers to a condition having a continuous even surface with a small number of visible flaws, such as air voids, bubbles, knots, grooves, pits and the like.

As used herein, the term “coat” or “coating” refers to the action of covering a surface or a substrate with a finishing, protecting, or enclosing layer. Coating can be finished by conventionally used techniques such as spreading, brushing, roller-coating, spraying etc.

As used herein, the term “primer” refers to an undercoat put on the substrate of a mold before additional layers of coating are applied to the mold. Primer provides a good adhesion with the subsequent layers and increases their durability.

As used herein, the term “cure” or “curing” refers to the toughening or hardening process of a material via chemical reactions in the system. Curing can be accelerated by heat.

As used herein, the term “demolding layer” refers to a layer of agents used to facilitate the removal of the cured object from the mold. The demolding layer faces the cavities in the mold and is in direct contact with the raw materials to be cured.

As used herein, the term “demold” or “demolding” refers to the action of separating the cured object from the mold. In case of using molds made by multiple pieces, demolding can be done by dissembling the pieces of the mold and releasing the cured object from the mold.

As used herein, the term “cycle” refers to a series of operations during which a construction material (e.g. concrete) is added, cured and demolded. In case of using non-repeatable demolding agents such as mineral oil, one cycle comprises the steps of coating the mold with demolding agents, adding construction materials to the mold, curing, demolding cured parts of construction materials, removing excess demolding agents and cleaning the mold. In case of using mold coated with multiple resin-based layers prepared according to this invention, one cycle comprises the steps of adding construction materials to the mold, curing, demolding cured parts of construction materials, and cleaning the mold.

As used herein, the term “substrate” as in “substrate of a mold” refers to a part of a mold facing the cavities and to a part of a mold to which surface treatment such as coating is applied.

As used herein, the term “void” as in “air void” refers to regions which contain something other than the considered material, particularly air.

As used herein, the term “cementitious material” refers to any solid inorganic material or substance that holds or draws other materials together in construction materials (e.g. paste, mortar or concrete) after reaction in an aqueous medium. For cement-containing construction materials, cementitious material refers to cement and optional supplementary cementitious materials. For construction materials with only geopolymer as the binding material, cementitious material refers to solid non-cement composition in geopolymer.

As used herein, the term “additives” refers to additives included in a formulated system to enhance physical or chemical properties thereof and to provide a desired result. Such additives include, but are not limited to, dyes, pigments, toughening agents, impact modifiers, rheology modifiers, plasticizing agents, thixotropic agents, natural or synthetic rubbers, filler agents, reinforcing agents, thickening agents, opacifiers, inhibitors, fluorescence or other markers, thermal degradation reducers, thermal resistance conferring agents, defoaming agents, surfactants, wetting agents, emulsifying agents, flame retardants, plasticizers, dispersants, flow or slip aids, biocides, and stabilizers.

Compound names starting with ‘poly’ designate substances, which formally contain per molecule, two or more of the functional groups. The compound itself can be monomeric, oligomeric or polymeric compound. For instance, a polyhydroxy compound is a compound having two or more hydroxy groups, a polyisocyanate is a compound having two or more isocyanate groups.

Unless otherwise identified, mortar refers to both cement mortar and geopolymer mortar. Unless otherwise identified, concrete refers to both cement concrete and geopolymer concrete.

Unless otherwise identified, all percentages (%) are “percent by weight”.

Unless otherwise identified, the temperature refers to room temperature and the pressure refers to ambient pressure.

Unless otherwise identified, the range described by “from” and “to” also includes the end point values. From example, the ratio from 10:1 to 10:9 include the end point values 10:1, 10:9, and the values in between.

In one aspect, the invention relates to a mold for molding construction materials characterized in that the mold is coated with multiple resin-based layers comprising at least a first epoxy resin-based primer layer and a second polyurethane resin-based demolding layer. Preferably, said demolding layer is coated on top of the primer layer.

In embodiments of the invention, the mold has a top side with an opening and at least one cavity, the cavity hosting construction materials to be cured/cured therein. The mold can be built in various shapes according to the application of the construction materials. For instance, the mold can be rectangular, cubic, polyhedral, cylindrical, tubular, spherical or any other form commonly used in the art. The mold can be integrally formed or formed by assembling pieces. Preferably, the mold is formed by assembling pieces.

In a preferred embodiment of the invention, the mold is in rectangular hexahedron shape having five rectangular plates, one of which is a bottom plate opposing the opening and four of which are side plates perpendicular to the bottom plate.

The mold is made of materials commonly used in the art, such as metal, alloy, wood, resin etc. or have such contacting surface to construction materials to be cured therein.

According to an embodiment of the invention, the mold is made of steel or have steel contacting surface to construction materials. According to another embodiment of the invention, the mold is made of aluminum or have aluminum contacting surface to construction materials. According to yet another embodiment of the invention, the mold is made of plywood or have plywood contacting surface to construction materials.

For the purpose of the present invention, the primer is coated on the substrate of the mold by common methods used in the art for coating a substrate, such as brushing or spraying.

The primer is applied for providing sufficient bonding between the substrate and the subsequently coated layer, preferably the demolding layer, and for improving the adhesion and durability of the demolding layer. Without the primer layer, the demolding layer is easily peeled off during the repeated cycles.

For the purpose of the present invention, the primer is based on epoxy resin. Epoxy resins important in industry are obtainable via reaction of epichlorohydrin with compounds comprising at least two, preferably two, reactive hydrogen atoms, in particular with polyols comprising two aromatic or aliphatic 6-membered rings. Preferred epoxy resins of the invention are diglycidyl ether diols selected from the group consisting of diglycidyl ether of bisphenol A, diglycidyl ether of bisphenol F, diglycidyl ether of hydrogenated bisphenol A, diglycidyl ether of hydrogenated bisphenol F, and any mixture thereof. Preferably, the epoxy resins are bisphenol A epoxy resins.

Particularly, the epoxy resin-based primer layer contains the reaction product from a composition comprising bisphenol A epoxy resin, at least one amine-based curing agent, at least one accelerating agent and optional additives selected from the group consisting of anti-rust fillers, mica powder, pigments, defoamers, wetting dispersants, coupling agents, thickening agents and any mixture thereof. For those skilled in the art, the additives are commercially available. The formulation additives, if any, are presented in an amount commonly used in the art.

Said epoxy resin-based composition is preferably a two-component composition comprising:

(I) Component A comprising bisphenol A epoxy resin; and

(II) Component B comprising:

(i) at least one amine-based curing agent; and

(ii) at least one accelerating agent,

wherein the weight ratio of Component A to Component B is in the range of 10:1 to 10:9.

Two-component composition, sometimes also called two-package or 2K composition, is a common system for epoxy and polyurethane. Two-component refers to a process in which two resin packages are mixed immediately prior to the application, wherein one package contains a resin with reactive chemical groups and the other package contains a resin and/or a curing agent capable of reacting with the reactive chemical groups. By “a two-component” composition it is meant a composition comprising two essential components. Such a composition may additionally comprise one or more other optional components.

Bisphenol A epoxy resins are commonly employed in producing primers and such prior art resins can be employed in the present invention. In particular, the bisphenol A epoxy resin of the present invention is a diglycidyl ether diol bisphenol A selected from the group consisting of diglycidyl ether of bisphenol A, diglycidyl ether of hydrogenated bisphenol A, and any mixture thereof. Preferably, the bisphenol A epoxy resin has an epoxy equivalent (ISO 3001) of from 100 to 1,000 g/equivalent, more preferably from 150 to 600 g/equivalent, even more preferably from 150 to 300 g/equivalent. Illustrative bisphenol A type epoxy resins include Epikote™ series from Shell Chemicals Corp., Araldite® series from Huntsman, Dow Epoxy DER series and DEN series, Epicron series from Dainippon Inki Kagaku Kogyo Co., Epototo series from Toto Kasei Co. and the like.

Commercial amine-based curing agents for epoxy resin are commonly employed in curing epoxy resin and such prior art amine-based curing agents can be employed in the present invention. The amine-based curing agent of the present invention is preferably selected from aliphatic, cycloaliphatic or aromatic primary and secondary amines. Preferably, the amine-based curing agents have an active hydrogen equivalent weight of more than or equal to 60 g/equivalent, preferably of more than or equal to 90 g/equivalent. Preferably, the amine-based curing agent is selected from a polyamine or polyaminoamide adduct to ensure a good stability of the epoxy resin under high temperature. More preferably the amine-based curing agent is a polyaminoamide adduct. Illustrative amine-based curing agents include Aradur® series and Ancamin® series from Huntsman, EPILINK® series and Sun-mide® series from Evonik.

To accelerate the curing of epoxy resins, especially at ambient temperature, an accelerating agent is used. The accelerating agents suitable for use in the practice of the invention include: tertiary amines, imidazole derivatives, other heterocyclic nitrogen compounds, pyridine derivatives, nucleic acids, aromatic amines, poly-functional amines, phosphines, phosphazenes, amides, metal amides, metal alkoxides, metal hydroxides, metal cyanides, and certain other metal salts. Non-limiting examples of accelerating agents include: tris(dimethylaminomethyl)phenol (DMP-30), (dimethylaminomethyl)phenol (DMP-10), benzyldimethylamine (BDMA), tri-ethanolamine, amino-n-propyldiethanolamine, N,N-dimethyldipropylenetriamine, and the like.

In a preferred embodiment, the epoxy resin-based primer layer contains the reaction product from a two-component composition comprising:

(I) Component A comprising ≥50 wt. % to ≤100 wt. % by weight of Component A of bisphenol A epoxy resin; and

(II) Component B comprising:

(i) ≥90 wt. % to ≤99 wt. % by weight of Component B of at least one amine-based curing agent; and

(ii) ≥1 wt. % to ≤10 wt. % by weight of Component B of at least one accelerating agent,

wherein the weight ratio of Component A to Component B is in the range of 10:1 to 10:9, preferably from 5:1 to 10:9, more preferably from 3:1 to 10:9.

Optionally, said epoxy resin-based composition further comprises additives known to person skilled in the art, which are selected from the group of anti-rust fillers, mica powder, pigments, defoamers, wetting dispersants, coupling agents, thickening agents, rheology modifiers and any mixture thereof. Preferably, the additives are added to Component A of said epoxy resin-based composition. In a preferred embodiment, the at least one additive is present in the range of ≥0.1 wt. % to ≤50 wt. %, preferably in the range of ≥20.2 wt. % to ≤30 wt. % based on the total weight of the two-component composition.

For the purpose of the invention, the primer layer is formed by coating the epoxy resin-based composition according to the present invention onto the substrates of a mold and curing said epoxy resin-based composition on the mold. According to a preferred embodiment of the invention, the primer is cured in a one-stage process. In one embodiment, the primer is cured at 5° C. for not less than 48 hours. In an alternative embodiment, the primer is cured at 20° C. to 25° C. for not less than 20 hours. In an alternative embodiment, the primer is cured at 40° C. for not less than 8 hours. In an alternative embodiment, the primer is cured at 60° C.-80° C. for not less than 2 hours.

In a preferred embodiment of the invention, the primer composition is coated and cured on the substrate of the mold to form a primer layer of a thickness of ≥0.1 mm to ≤2 mm. Preferably, the primer layer has a thickness of ≥0.1 mm to ≤1 mm. More preferably, the primer layer has a thickness of ≥0.1 mm to ≤0.5 mm. Even more preferably, the primer layer has a thickness of 0.2 mm. Generally for the purpose of this invention the thickness of coating layers is measured by PosiTector 6000. 12 points of the coating surface are tested to get an average value of the thickness.

Shore D hardness of the cured primer is preferably not less than 30. More preferably, Shore D hardness is not less than 50. Even more preferably, Shore D hardness is not less than 70, preferably determined according to DIN53505.

Preferably said primer layer has a glass transition temperature of not less than 60° C. Generally for the purpose of this invention, the glass transition temperature is determined by the differential scanning calorimetry method (DSC method).

The cured primer layer has a good adhesion with the substrate. Preferably, the primer has an adhesion with the substrate of not less than 1.0 Mpa. More preferably, the primer has an adhesion with the substrate of not less than 2.5 Mpa, wherein the substrate is steel. Generally for the purpose of this invention the adhesion (Pull-off adhesion) is determined according to ASTM D4541 by Posited AT-A.

For the purpose of the present invention, the demolding layer is coated on the underlying layer by common methods used in the art for coating, such as spreading, brushing or spraying.

In a preferred embodiment of the invention, the demolding layer is coated on top of the primer layer. The mold is therefore coated with two resin-based layers comprising a first layer of primer layer and a second layer of demolding layer as described hereinafter.

For purpose of the present invention, the demolding layer is based on a polyurethane resin. Particularly, said polyurethane resin-based demolding layer contains the reaction product from a composition comprising polyol, water, polyisocyanate, metal component, and optional additives selected from the group consisting of fillers, dispersants, plasticizers, defoamers, wetting dispersants, thickening agents and any mixture thereof. For those skilled in the art, the additives are commercially available. The formulation additives, if any, are presented in an amount commonly used in the art.

More particularly, the demolding layer contains the reaction product from a polyurethane resin-based composition comprising a first saturated polyhydroxy component, optionally a second saturated polyhydroxy component, optionally further polyhydroxy components, wherein the second polyhydroxy compound is different from the first polyhydroxy compound, at least one polyisocyanate, at least one metal component and water.

The term ‘saturated’ herein denotes that the polyhydroxy compound has only single bonds between carbon atoms.

Even more particularly, the demolding layer contains the reaction product from a two-component composition comprising:

(I) Component C comprising:

(i) a first saturated polyhydroxy compound selected from the group consisting of polyether polyol, polyester polyol, C2 to C32 alkyl polyol and sugar alcohol;

(ii) optionally a second saturated polyhydroxy compound selected from the group consisting of polyether polyol, polyester polyol, C2 to C32 alkyl polyol and sugar alcohol,

wherein the second polyhydroxy compound is different from the first polyhydroxy compound;

(iii) water; and

(iv) at least one metal component selected from the group consisting of metal oxide, metal hydroxide, metal aluminate and metal silicate; and

(II) Component D comprising at least one polyisocyanate.

In a preferred embodiment, the first polyhydroxy compound of the present invention is selected from the group consisting of polyether polyol, polyester polyol, C2 to C32 alkyl polyol and sugar alcohol. Preferably, the first polyhydroxy compound of the present invention is selected from the group consisting of polyether polyol and polyester polyol. Preferably the polyether polyol or polyester polyol has a hydroxyl value in the range of ≥30 to ≤600 mg KOH/g, more preferably in the range of ≥30 to ≤450 mg KOH/g determined according to DIN 53240.

In an embodiment, the first polyhydroxy compound is a polyether polyol. Preferably the polyether polyol has a functionality in the range of ≥1.7 to ≤6, more preferably in the range of ≥1.5 to ≤3.5, which denotes the average number of functional groups on a given molecule.

Examples of the polyether polyol include, but are not limited to, polyethyleneoxide polyol and polypropyleneoxide polyol, in particular polyethyleneoxide diol, poly-propyleneoxide diol, polyethyleneoxide triol and polypropyleneoxide triol. Such polyether polyols are known to the person skilled in the art and therefore, the present invention is not limited by the choice of such polyols. Moreover, commercially available polyether polyol such as, but not limited to, Arcol® from Covestro, Poly-THF® from BASF, ethylene oxide-terminated (“EO-endcapped”, ethylene oxide-endcapped) polypropylenoxide polyols, styrene-acrylonitrile-grafted polyetherpolyols, e.g. Lupranol® from BASF SE, Voranol™ polyols, Voralux™ polyols, Specflex™ polyols from Dow Chemicals and Desmophen® from Covestro.

In an embodiment, the first polyhydroxy compound is a polyester polyol. Preferably the polyester polyol has a functionality in the range of ≥2 to ≤6, more preferably in the range of ≥2 to ≤5 and most preferably in the range of ≥2 to ≤4. Polyester polyol as suitable polyhydroxy compound for the present invention comprise of at least one saturated and/or unsaturated polycarboxylic acid and at least one C2 to C10 alkyl polyol. The at least one polycarboxylic is preferably an aliphatic dicarboxylic acid of the general formula HOOC—(CH2)n-COOH, where n is a real number from 2 to 20, examples being succinic acid, adipic acid, glutaric acid, succinic acid, pimelic acid, suberic acid, azelaic acid, sebacic acid, heptane dicarboxylic acid, octane dicarboxylic acid, nonane dicarboxylic acid, decane dicarboxylic acid, undecane dicarboxylic acid and dodecane dicarboxylic acid. The dicarboxylic acids can be used individually or as mixtures, e.g. in the form of a mixture of succinic acid, glutaric acid and adipic acid. The at least one C2 to C10 alkyl polyol is preferably selected from the group consisting of ethanediol, 1,3-propanediol, 1,4-butanediol, 1,5-pentanediol, 1,6-hexanediol, 1,10-decanediol, 2,2-dimethyl-1,3-propanediol, 2-methyl-1,3-propanediol, 1,2-propanediol, 3-methyl-1,5-pentanediol, dialkylene ether glycols such as diethylene glycol and dipropylene glycol, 2,2-bis(hydroxymethyl)1,3-propanediol and trimethylolpropane.

In a preferred embodiment, the first saturated polyhydroxy compound is selected from the group consisting of polyethylene glycol, polypropylene glycol and polypropylenoxide triol.

In a preferred embodiment, the second polyhydroxy compound of the present invention is selected from the group consisting of polyether polyol, polyester polyol, C2 to C32 alkyl polyol and sugar alcohol. Preferably, the second polyhydroxy compound of the present invention is selected from the group consisting of C2 to C32 alkyl polyol and sugar alcohol.

In an embodiment, the first or the optional second polyhydroxy compound is a C2 to C56 alkyl polyol, preferably a C2 to C32 alkyl polyol, more preferably a C2 to C12 alkyl polyol, particularly preferably a C2 to C6 alkyl polyol. Examples of C2 to C32 alkyl polyols are ethanediol, propanediol, neopentylglycol, butanediol, pentanediol, diethylene glycol, triethylene glycol, dipropylene glycol, tripropylene glycol, cyclohexanedimethanol, trimethylol propane, glycerol, trimethylolethane, pentaerithrytol, hexanediol, heptanediol, octanediol, nonanediol, decanediol, un-decanediol, dodecanediol, tridecanediol, tetradecanediol, pentadecanediol, hexa-decanediol, heptadecanediol, octadecanediol, nonadecanediol, eicosanediol, hene-icosanediol, docosanediol, tetracosanediol, hexacosanediol, heptacosanediol, octa-cosanediol, nonacosanediol, triacontanediol, dotriacontanediol and isomers thereof.

In an embodiment, the first or the optional second polyhydroxy compound is a sugar alcohol. The term “sugar alcohol” refers to alcohols derived from sugars. Sugar alcohols have the general formula HOCH₂(CHOH)ₙCH₂OH, wherein n is a real number in the range of ≥2 to ≤10. Suitable examples of sugar alcohols include but are not limited to xylitol, lactitol, erythritol, mannitol, sorbitol, galactitol and maltitol.

In a more preferred embodiment, the second polyhydroxy compound is selected from the group consisting of propanediol, butanediol, glycerol, pentaerythritol and sorbitol.

Preferably, the first polyhydroxy compound has a weight average molecular weight Mw in the range of ≥100 to ≤20,000 g/mol, preferably in the range of ≥200 to ≤10,000 g/mol, still more preferably in the range of ≥2200 to ≤6,000 g/mol determined according to DIN 55672-1. Preferably, the optional second polyhydroxy compound has a weight average molecular weight Mw in the range of ≥50 to ≤2,000 g/mol, preferably in the range of ≥50 to ≤1,000 g/mol and most preferably in the range of ≥50 to ≤500 g/mol determined according to DIN 55672-1.

In a preferred embodiment, the amount of the first saturated polyhydroxy compound is in the range of ≥5.0 wt. % to ≤40 wt. %, based on the total weight of the two-component composition. In a preferred embodiment, the amount of the second saturated polyhydroxy compound, is in the range of ≥0.2 wt. % to ≤20 wt. %, based on the total weight of the two-component composition.

The amount of water present in the two-component coating composition is in the range of ≥21 wt. % to ≤50 wt. %, preferably in the range of ≥5 wt. % to ≤540 wt. %, more preferably in the range of ≥10 wt. % to ≤40 wt. %, based on the total weight of the two-component composition.

In a preferred embodiment, the at least one metal component is based on the oxides, hydroxides, aluminates and silicates of elements of group I B, II A, II B, VI B, VII B in the periodic table, preferably group II A. Preferably, the at least one metal component is selected from the group consisting of magnesium oxide, magnesium hydroxide, calcium oxide and calcium hydroxide, more preferably calcium hydroxide and calcium oxide and most preferably calcium hydroxide.

In a preferred embodiment, the amount of the at least one metal oxide and/or the at least one metal hydroxide is in the range of ≥2 wt. % to ≤50 wt. %, preferably in the range of ≥5 wt. % to ≤40 wt. %, more preferably in the range of ≥10 wt. % to ≤40 wt. %, based on the total weight of the two-component composition.

The presence of such at least one metal component, particularly selected from calcium hydroxide and/or calcium oxide, quenches the CO₂ generated by the reaction of the isocyanate compounds and water thus prevents the formation of bubbles or blisters on the cured polyurethane resin's surface. A smooth surface of the polyurethane-based demolding layer is essential in producing molded objects with smooth surface.

For the purpose of the present invention, at least one polyisocyanate in Component D includes aliphatic polyisocyanate, cycloaliphatic polyisocyanate, aromatic polyisocyanate, modified polyisocyanate containing for example uretonimine groups, allophanate groups, isocyanurate groups, urethane groups and biuret groups. Suitable examples of polyisocyanate are pentamethylene diisocyanate, hexamethylene diisocyanate (HDI), isophorone diisocyanate (IPDI), 2,2,4- and 2,4,4-trimethyl-1,6-hexamethylene diisocyanate, tetramethoxybutane 1,4-diisocyanate, butane-1,4-diisocyanate, dicyclohexylmethane diisocyanate, cyclo-hexane 1,3- and 1,4-diisocyanate, 1,12-dodecamethylene diisocyanate, diisocyanates of dimeric fatty acids; lysine methyl ester diisocyanate, 1-isocyanato-3,3,5-trimethyl-5-isocyanatomethylcyclohexane, hydrogenated diphenylmethane diisocyanate (H12MDI), hydrogenated 2,4-tolylene diisocyanate, hydrogenated 2,6-tolylene diisocyanate, methylene diphenyl diisocyanate (MDI), 2,4-toluene diisocyanate (2,4-TDI), 2,6-toluene diisocyanate (2,6-TDI), naphthalene diisocyanate (NDI), tetramethylxylylene diisocyanate (TMXDI), p-xylylene diisocyanate, and mixtures of these compounds, polymeric methylene diphenyl diisocyanate, carbodiimide-modified methylene diphenyl diisocyanate, tris-(isocyanatohexyl)-isocyanurate and mixtures with the higher homologues thereof, tris-(isocyanatohexyl)-biuret or mixtures with the higher homologues. Preferably, the at least one polyisocyanate is selected from the group consisting of liquid oligomers and/or prepolymers. More preferably, the at least one polyisocyanate is selected from the group consisting of liquid oligomers and/or prepolymers of hexamethylene diisocyanate (HDI), methylene diphenyl diisocyanate (MDI) or a derivative of MDI such as polymeric methylene diphenyl diisocyanate, carbodiimide-modified methylene diphenyl diisocyanate.

The term ‘oligomer’ denotes a molecule that consists of 2-10 monomers but do not have necessarily a molecular mass distribution. The term ‘prepolymer’ refers to a monomer or system of monomers that have been reacted to an intermediate molecular mass state. This material is capable of further polymerization by reactive groups to a fully cured high molecular weight state.

Polymeric methylene diphenyl diisocyanate and carbodiimide-modified methylene diphenyl diisocyanate are commercially available, for e.g. Lupranat® M, Lupranat® MI and Lupranat® MM from BASF SE or Desmodur MDI-types from Covestro and polyisocyanate resin based on hexamethylene diisocyanate (HDI) is commercially available, for e.g. Desmodur N Types® from Covestro, Tolonate™ X Flo from Vencorex.

In a preferred embodiment, the at least one polyisocyanate in Component D is present in an amount in the range of ≥10 wt. % to ≤90 wt. %, preferably in the range of ≥20 wt. % to ≤80 wt. %, most preferably in the range of ≥30 wt. % to ≤80 wt. %, based on the total weight of the two-component composition.

In one embodiment, the polyurethane resin-based demolding layer contains the reaction product from a two-component composition comprising:

(I) Component C comprising:

(i) ≥0.2 wt. % to ≤40 wt. % of a first saturated polyhydroxy compound based on the total weight of the two-component composition selected from the group consisting of polyether polyol, polyester polyol, C2 to C32 alkyl polyol and sugar alcohol;

(ii) ≥1 wt. % to ≤50 wt. % of water based on the total weight of the two-component composition; and

(iii) ≥2 wt. % to ≤50 wt. % of at least one metal component selected from the group consisting of metal oxide, metal hydroxide, metal aluminate and metal silicate, by weight of the total weight of the two-component composition; and

(II) Component D comprising at least one polyisocyanate.

In another embodiment, the demolding layer contains the reaction product from a two-component polyurethane resin-based composition comprising:

(I) Component C comprising:

(i) ≥5.0 wt. % to ≤40 wt. % of a first saturated polyhydroxy compound based on the total weight of the two-component composition selected from the group consisting of polyether polyol, polyester polyol, C2 to C32 alkyl polyol and sugar alcohol;

(ii) ≥1 wt. % to ≤50 wt. % of water based on the total weight of the two-component composition; and

(iii) ≥2 wt. % to ≤50 wt. % of at least one metal component selected from the group consisting of metal oxide, metal hydroxide, metal aluminate and metal silicate, by weight of the total weight of the two-component composition; and

(II) Component D comprising ≥10 wt. % to ≤90 wt. % based on the total weight of the two-component composition of at least one polyisocyanate.

In an alternative embodiment, the demolding layer contains the reaction product from a two-component polyurethane resin-based composition comprising:

(I) Component C comprising:

(i) ≥25.0 wt. % to ≤40 wt. % of a first saturated polyhydroxy compound based on the total weight of the two-component composition selected from the group consisting of polyether polyol, polyester polyol, C2 to C32 alkyl polyol and sugar alcohol;

(ii) ≥0.2 wt. % to ≤20 wt. % by weight of the total weight of the two-component composition of a second saturated polyhydroxy compound selected from the group consisting of polyether polyol, polyester polyol, C2 to C32 alkyl polyol and sugar alcohol, wherein the second saturated polyhydroxy compound is different from the first saturated polyhydroxy compound;

(iii) ≥21 wt. % to ≤50 wt. % of water based on the total weight of the two-component composition; and

(iv) ≥2 wt. % to ≤50 wt. % of at least one metal component selected from the group consisting of metal oxide, metal hydroxide, metal aluminate and metal silicate, by weight of the total weight of the two-component composition; and

(II) Component D comprising ≥10 wt. % to ≤90 wt. % based on the total weight of the two-component composition of at least one polyisocyanate.

The two-component composition of the present invention further may comprise catalysts and additives selected from the group consisting of emulsifying agents, flame retardants, antimicrobial agents, pigments, defoamers, stabilizers, plasticizers, diluents, wetting and dispersing agents and fillers.

In an embodiment, if present, the at least one catalyst is selected from the group consisting of amine catalysts, alkanolamine catalysts and metal catalysts. Preferably, the catalyst is a tertiary aliphatic amine catalyst selected from the group consisting of triethylenediamine, pentamethyldiethylenetriamine, dimethylcyclohexyl-amine, 2,2′-dimorpholinodiethyl ether, 2-(2-dimethyl-aminoethoxy) ethanol, 2-dimethylaminoethyl 3-dimethyl aminopropyl ether, bis(2-dimethylaminoethyl)ether, N,N-dimethylpiperazine, N-(2-hydroxyethoxyethyl)-2-aza-norboranes, Jeffcat™, N,N,N,N-tetramethylbutane-1,3-diamine, N,N,N,N-tetra-methylpropane-1,3-diamine and N,N,N,N-tetramethylhexane-1,6-diamine, preferably 2,2′-dimorpholinodiethylether. In a preferred embodiment, the amount of the at least one catalyst is in the range of ≥0.05 wt. % to ≤5.0 wt. %, preferably in the range of ≥0.5 wt. % to ≤5.0 wt. %, based on the total weight of the two-component composition.

In a preferred embodiment, the at least one additive is present in the range of ≥0.1 wt. % to ≤50 wt. %, preferably in the range of ≥0.2 wt. % to ≤30 wt. % based on the total weight of the two-component composition.

It was found that the combination of at least one polyisocyanate and water with at least one polyhydroxy compound and at least one metal component described herein results in a polyurethane resin of satisfactory curing speed, good applicability and good mechanical properties, suitable to be used as a demolding layer.

For the purpose of the invention, the demolding layer is formed by coating the polyurethane-based composition according to the present invention on the top of the underlying layer, preferably the primer layer, and curing said polyurethane-based composition. According to one embodiment of the invention, the demolding layer is cured in a one-stage process. In one embodiment, the demolding layer is cured at 5° C. to 40° C. for not less than 60 hours. In another embodiment, the demolding layer is cured at 20° C. to 25° C. for not less than 20 hours. In an alternative embodiment, the demolding layer is cured at 30° C. to 40° C. for not less than 3 hours.

According to an alternative embodiment of the invention, the demolding layer is cured in a two-stage process. In one embodiment, the demolding layer is cured at 5° C. to 35° C. for not less than 2 hours and further curing at 60° C. to 80° C. for not less than 2 hours. Preferably, the demolding layer is cured at 20° C. to 25° C. for not less than 2 hours and further curing at 60° C. to 80° C. for not less than 2 hours.

In a preferred embodiment of the invention, the demolding layer is coated and cured on the underlying layer at a thickness of ≥0.1 mm to ≤2 mm. Preferably, the demolding layer has a thickness of ≥0.1 mm to ≤1 mm. More preferably, the demolding layer has a thickness of ≥0.1 mm to ≤0.5 mm. In a particularly preferable embodiment, the demolding layer has a thickness of 0.2 mm.

In a preferred embodiment of the invention, Shore D hardness of the cured demolding layer is not less than 60. Preferably, Shore D hardness is not less than 70, preferably determined according to DIN53505.

In a preferred embodiment of the invention, the contact angle of the cured demolding layer is not less than 70°. Preferably the contact angle is measured by Dataphysics OCA. 5 points of the coating surface are tested to get an average value of the contact angle.

The demolding layer has a good adhesion with the underlying layer. In one embodiment, the demolding layer has an adhesion to the surface of the primer layer of not less than 2.5 Mpa, preferably measured according to ASTM D4541.

In another aspect, the invention also relates to the use of such mold in making molded parts of construction materials having smooth surface.

In a further aspect, the invention relates to a method for making molded construction materials, comprising the steps of:

I) adding construction materials into a mold for molding construction materials characterized in that the mold is coated with multiple resin-based layers comprising at least a first epoxy resin-based primer layer and a second polyurethane resin-based demolding layer;

II) curing the construction materials to form cured parts of construction materials; and

III) demolding the cured parts of construction materials from the mold.

Preferably step I) to III) are repeated for not less than twice. More preferably step I) to III) are repeated for not less than 10 times, preferably more than 20 times, more preferably more than 30 times, even more preferably more than 50 times.

The construction materials are any construction material known to persons skilled in the art that are suitable to be molded according to the present invention. Preferably, the construction material comprises cementitious material, aggregates, water, and other materials, for example additives. In the context of this invention, aggregates are fine to coarse grained particulate material used in construction, including sand, gravel, crushed stone, slag, recycled concrete and synthetic aggregates, preferably sand as fine aggregate and gravel as coarse aggregate. When the construction material is a mixture with no aggregate, the system is referred to as a paste, e.g. cement or geopolymer paste. When the construction material is a mixture with fine aggregates, the system is referred to as a mortar, e.g. a cement mortar comprising sand, cement, water and optional additives. When the construction material is a mixture with fine and coarse aggregates, the system is referred to as concrete, e.g. an OPC concrete comprising Portland cement, sand, gravel, water and optional additives. The examples are not meant to be limiting.

In one embodiment of this invention, the mold and the method are used to make molded parts of cement paste. In another embodiment of this invention, the mold and the method are used to make molded parts of geopolymer paste. In an alternative embodiment of this invention, the mold and the method are used to make molded parts of cement mortar. In yet another embodiment of this invention, the mold and the method are used to make molded parts of geopolymer mortar. In one further embodiment of this invention, the mold and the method are used to make molded parts of cement concrete. In yet an alternative embodiment of this invention, the mold and the method are used to make molded parts of geopolymer concrete.

In one embodiment of this invention, the construction material suitable for this invention is a paste comprising at least 1000-1500 kg/m³ cementitious material and 300-800 kg/m³ water, preferably 1200-1300 kg/m³ cementitious material and 500-600 kg/m³ water. In another embodiment of this invention, the construction material suitable for this invention is a mortar comprising at least 600-900 kg/m³ cementitious material, 1000-1300 kg/m³ sand as fine aggregate, and 200-500 kg/m³ water, preferably 700-800 kg/m³ cementitious material, 1100-1200 kg/m³ sand as fine aggregate, and 300-400 kg/m³ water. In yet another embodiment of this invention, the construction material suitable for this invention is a paste comprising at least 300-700 kg/m³ cementitious material, 600-1000 kg/m³ sand as fine aggregate, 600-1000 kg/m³ gravel as coarse aggregate, and 100-400 kg/m³ water, preferably 500-600 kg/m³ cementitious material, 700-900 kg/m³ sand as fine aggregate, 700-900 kg/m³ gravel as coarse aggregate, and 200-300 kg/m³ water.

In a preferred embodiment, the mold and method of this invention are used to make molded parts of concrete with smooth surface. Preferably said construction material is a concrete comprising cementitious material, aggregates, and water, wherein the weight ratio between water to cementitious material is from 0.25 to 0.50, preferably from 0.27 to 0.45, more preferably from 0.3 to 0.45.

Said cementitious material is advantageously at least one inorganic binding material selected from the group consisting of hydraulic binding material, latent hydraulic binding material, pozzolanic binding material, alkali-activated alumosilicate binding material and mixtures thereof.

For the purposes of the present invention, a hydraulic binding material is advantageously cement, for example a Portland cement, a calcium aluminate cement, a magnesium phosphate cement, a magnesium potassium phosphate cement, a calcium sulfoaluminate cement, and also mixtures thereof. Such cements are well known to people skilled in the art.

For the purposes of the present invention, a latent hydraulic binding material is preferably a cementitious material in which the molar ratio of (CaO+MgO):SiO₂ is between 0.8 and 2.5 and more preferably between 1.0 and 2.0. Said latent hydraulic binding material is advantageously industrial and/or synthetic slags, i.e. waste products from industrial processes (e.g. metallurgical process), and/or synthetically reproduced slags. More particularly, said slag is selected from blast furnace slag, slag sand, ground slag sand, electrothermic phosphorus slag, stainless-steel slag, and also mixtures thereof. Even more particularly, said slag is blast furnace slag, which is a waste product of the blast furnace process and generally contains about 30% to 45% by weight CaO, about 4% to 17% by weight MgO, about 30% to 45% by weight SiO₂ and about 5% to 15% by weight Al₂O₃.

For the purposes of the present invention, a pozzolanic binding material is advantageously selected from amorphous silica, preferably precipitated silica, pyrogenic silica and microsilica, finely ground glass, fly ash, preferably brown coal fly ash and mineral coal fly ash, metakaolin, natural pozzolans such as tuff, trass, pumice and volcanic ash, natural and synthetic zeolites, and also mixtures thereof. Particularly, said pozzolanic binding material is selected from microsilica, fly ash, metakaolin and any mixture thereof. Microsilica, also called silica dust, is a by-product of silicon or ferrosilicon manufacture and likewise consists very largely of amorphous SiO₂ powder of diameter in the order of magnitude of 0.1 pm and of specific surface area in the order of magnitude of 15 to 30 m²/g. Fly ashes are formed in operations including the combustion of coal in power stations. Class C fly ash (brown coal fly ash) contains, generally about 10% by weight CaO, whereas class F fly ash (mineral coal fly ash) contains less than 8% by weight, preferably less than 4% by weight and typically about 2% by weight CaO. Metakaolin (Al₂Si₂O₇) is formed in the dehydrogenation of kaolin. Pure metakaolin contains about 54% by weight SiO₂ and about 46% by weight Al₂O₃.

For the purposes of the present invention, “alkali-activated alumosilicate binding materials” (geopolymer raw materials) are binding systems which comprise latent hydraulic and/or pozzolanic binding materials as defined above and also alkaline activators, such as aqueous solutions of alkali metal carbonates, alkali metal fluorides, alkali metal hydroxides, alkali metal aluminates, alkali metal silicates (such as soluble water glass) and/or mixtures thereof. The low content or even absence of cement rules out hydraulic curing of the cement component in alkali-activated alumosilicate binding materials. In the context of the present invention, the dry alkaline activator or the solids content of the aqueous alkaline activator is considered as part of the cementitious material. Mixtures of dry alkaline activators and aqueous alkaline activators or aqueous alkaline activators alone can be used advantageously.

Metal in said alkali metal carbonates, alkali metal fluorides, alkali metal hydroxides, alkali metal aluminates, alkali metal silicates are advantageously from Li, Na, K, NH₄ and mixtures thereof, preferably from Na and K. Said alkali metal silicate is advantageously selected from compounds having the empirical formula mSiO₂-nM₂O, where M stands for Li, Na, K and NH₄, and also mixtures thereof, preferably for Na and K. The molar ratio m:n is advantageously 0.5 to 4.0, preferably 0.6 to 3.0 and more particularly 0.7 to 2.5. The alkali metal silicate is preferably water glass, more preferably a liquid water glass, and more particularly a sodium or potassium water glass.

For the purposes of the present invention, cementitious material is advantageously at least one selected from the group of cement, slag, pozzolan, amorphous silica, fly ash, metakaolin, and also mixtures thereof. In cement-containing binder system (e.g. composite cement), non-cement solid composition is also referred to as supplementary cementitious material, such as slag, pozzolan, amorphous silica, fly ash, metakaolin and the like, whereas in geopolymer binder system, such non-cement solid composition is referred to as geopolymer raw material.

In embodiments of the invention, the concrete is a cement concrete composition comprising at least cement, sand, gravel and water, wherein cement acts as binder. Particularly, the concrete has a water to cement weight ratio of from 0.25 to 0.5. More particularly, the concrete has a water to cement weight ratio of from 0.27 to 0.45. More particularly, the concrete has a water to cement weight ratio of from 0.3 to 0.45.

The cement may be a Portland cement (OPC), a calcium aluminate cement, a magnesium phosphate cement, a magnesium potassium phosphate cement, a calcium sulfoaluminate cement or any other suitable cement known to people in the art. The cement may also contain supplementary cementitious material such as blast furnace slag, fly ash, silica fume, pozzolan and the like. In other words, the cements suitable for concrete in this invention are advantageously cements and/or composite cements in categories GEM I-V, and any mixture thereof.

In embodiments of the invention, the concrete is a geopolymer concrete comprising at least alkali activator, latent hydraulic and/or pozzolanic cementitious materials (geopolymer raw materials), sand, gravel and water. The alkali medium for activating geopolymer raw materials consists typically of aqueous solutions of alkali metal carbonates, alkali metal fluorides, alkali metal hydroxides, alkali metal aluminates and/or alkali metal silicates, such as soluble water glass, and any mixture thereof. In preferred embodiments of the invention, said metal is preferably Na⁺, K⁺, Li⁺ and the like, more preferably Na⁺, K⁺. In preferred embodiments of the invention, the alkali activator is at least one selected from NaOH, KOH, Na₂CO₃, K₂CO₃, potassium water glass, sodium water glass, and mixtures thereof. More preferably, the alkali activator is NaOH, KOH or mixture thereof. The geopolymer raw material is at least one latent hydraulic and/or pozzolanic binders as defined above. Preferably, the geopolymer raw material is at least one selected from the group consisting of metakaolin, activated clay, fly ash, pozzolans, slags, amorphous silica or mixtures thereof. In a preferred embodiment, the cementitious material is at least one selected from the group consisting of blast furnace slag, type C and/or type F fly ash, metakaolin, microsilica, volcanic ash and the like. More preferably from blast furnace slag, type F fly ash and microsilica.

In a preferred embodiment of the invention, the geopolymer raw materials comprise 150-400 kg/m³ of fly ash, 150-400 kg/m³ of slag, 30-50 kg/m³ of microsilica. In a more preferred embodiment of the invention, the total weight of geopolymer raw materials is 250-600 kg/m³, more preferably 350-500 kg/m³. More particularly, the concrete has a water to geopolymer raw material weight ratio of from 0.25 to 0.5. Even more particularly, the concrete has a water to geopolymer raw material weight ratio of from 0.27 to 0.45, more particularly from 0.3 to 0.45.

Based on the composition of the geopolymer raw material, the geopolymer can be slag-based geopolymer, rock-based geopolymer, fly ash-based geopolymer, slag/fly ash-based geopolymer, ferro-sialate-based geopolymer or any other suitable geopolymer known to people in the art.

The concrete may be further admixed with admixtures in the form of dispersants known to person skilled in the art to improve the processing properties and work-ability.

It is obvious for a person skilled in the art that such cementitious materials as described above are also applicable to other construction materials such as paste or mortar suitable to be molded by using the mold and method of this invention.

The construction material is added to the mold by means commonly used in the art. In one embodiment, the construction material is poured into the mold. In another embodiment, the construction material is injected into the mold. In an alternative embodiment, the construction material is pumped into the mold.

According to a preferred embodiment of the invention, the concrete is cured in a one-stage process. In one embodiment, the concrete is cured at 5° C. to 35° C. for not less than 24 hours. Preferably, the concrete is cured at 20° C. to 25° C. for not less than 20 hours.

According to a preferred embodiment of the invention, the cement concrete is cured in a one-stage process. In one embodiment, the cement concrete is cured at 5° C. to 35° C. for not less than 24 hours. Preferably, the cement concrete is cured at 20° C. to 25° C. for not less than 20 hours.

According to another preferred embodiment of the invention, the cement concrete is cured in a two-stage process. In one embodiment, the cement concrete is cured at 20° C. to 25° C. for not less than 0.5 hour and further curing at 40° C. to 70° C. for not less than 3 hours.

According to a preferred embodiment of the invention, the geopolymer concrete is cured at 20° C. to 25° C. for not less than 20 hours, preferably for not less than 24 hours.

When the resin-coated mold according to the present invention is used to make molded parts of construction, it's been surprisingly found that the mold can be used for multiple cycles without further treatment. In embodiments of the invention, step I) to III) are repeated for not less than twice. Preferably, step I) to III) are repeated for not less than 10 times. More preferably, step I) to III) are repeated for not less than 20 times. Even more preferably, step I) to III) are repeated for not less than 30 times. Even more preferably, step I) to III) are repeated for not less than 40 times. Most preferably, step I) to III) are repeated for not less than 50 times.

In a further aspect, the invention relates to the application of the method and to the molded parts of construction materials obtained from the method for making molded construction materials, comprising the steps I), II) and III).

Particularly, the invention provides molded parts of construction materials with improved surface finish and reduced surface air voids. Preferably the construction material is concrete and the percentage of total air voids area on the surface of the cured concrete part is not more than 0.9%, preferably not more than 0.8%, more preferably not more than 0.6%, even more preferably not more than 0.5% based on the total surface area of the cured concrete part. Generally for the purpose of this invention the percentage of Air Voids Area is determined by image analysis software ImageJ according to the procedure described in Example 6.

In yet another aspect, the invention relates to a method for making a resin-coated mold comprising the steps of:

a) coating an epoxy resin-based composition onto the substrate of the mold to form a first primer layer and curing the first primer layer; and

b) coating a polyurethane resin-based composition onto the surface of the underlying layer, preferably the first primer layer, to form a second demolding layer and curing the second demolding layer.

Preferably said epoxy resin-based composition in step a) comprises bisphenol A epoxy resin, at least one amine-based curing agent, at least one accelerating agent and optional additives selected from the group consisting of anti-rust fillers, mica powder, pigments, defoamers, wetting dispersants, coupling agents, thickening agents and any mixture thereof.

Preferably said epoxy resin-based composition in step a) is a two-component composition comprising:

(I) Component A comprising ≥50 wt. % to ≤100 wt. % by weight of Component A of bisphenol A epoxy resin; and

(II) Component B comprising:

(i) ≥90 wt. % to ≤99 wt. % by weight of Component B of at least one amine-based curing agent; and

(ii) ≥1 wt. % to ≤10 wt. % by weight of Component B of at least one accelerating agent,

wherein the weight ratio of Component A to Component B is in the range of 10:1 to 10:9.

Preferably said polyurethane resin-based composition in step b) comprises polyol, water, polyisocyanate, metal component, and optional additives selected from the group consisting of fillers, dispersants, plasticizers, defoamers, wetting dispersants, thickening agents and any mixture thereof.

Preferably said polyurethane resin-based composition in step b) is a two-component composition comprising:

(I) Component C comprising:

(i) ≥0.2 wt. % to ≤40 wt. % of a first saturated polyhydroxy compound based on the total weight of the two-component composition selected from the group consisting of polyether polyol, polyester polyol, C2 to C32 alkyl polyol and sugar alcohol;

(ii) ≥1 wt. % to ≤50 wt. % of water based on the total weight of the two-component composition; and

(iii) ≥2 wt. % to ≤50 wt. % of at least one metal component selected from the group consisting of metal oxide, metal hydroxide, metal aluminate and metal silicate, by weight of the total weight of the two-component composition; and

(II) Component D comprising at least one polyisocyanate.

Preferably said Component C further comprises ≥0.2 wt. % to ≤20 wt. % by weight of the total weight of the two-component composition of a second saturated polyhydroxy compound selected from the group consisting of polyether polyol, polyester polyol, C2 to C32 alkyl polyol and sugar alcohol, wherein the second saturated polyhydroxy compound is different from the first saturated polyhydroxy compound.

Preferably, the first saturated polyhydroxy compound in Component C has a weight average molecular weight Mw in the range of ≥100 to ≤20,000 g/mol and the second polyhydroxy compound in Component C has a weight average molecular weight Mw in the range of ≥50 to ≤2,000 g/mol.

Preferably the at least one polyisocyanate in Component D is a liquid oligomer or prepolymer.

Preferably, said polyisocyanate is at least one selected from the group consisting of pentamethylene diisocyanate, hexamethylene diisocyanate, isophorone diisocyanate, 2,2,4- and 2,4,4,-trimethyl-1,6-hexamethylene diisocyanate, tetramethoxybutane 1,4-diisocyanate, butane-1,4-diisocyanate, dicyclohexylmethane diisocyanate, cyclohexane 1,3- and 1,4-diisocyanate, 1,12-dodecamethylene diisocyanate, diisocyanates of dimeric fatty acids, lysine methyl ester diisocyanate, 1-isocyanato-3,3,5-trimethyl-5-isocyanatomethylcyclohexane, hydrogenated diphenylmethane diisocyanate, hydrogenated 2,4-tolyene diisocyanate, hydrogenated 2,6-tolylene diisocyanate, methylene diphenyl diisocyanate, toluene diisocyanate, naphthalene diisocyanate, polymeric methylene diphenyl diisocyanate, and carbodiimide-modified methylene diphenyl diisocyanate.

Preferably, the amount of the at least one polyisocyanate in Component D is in the range of ≥10 wt. % to ≤90 wt. % based on the total weight of the two-component composition.

Preferably said mold is made of metal or plywood and/or has metallic or plywood contacting surfaces to concrete parts and preferably is made of steel, aluminum or plywood or has preferably steel, aluminum or plywood contacting surfaces to concrete parts.

Preferably said primer in step a) is i) cured at 5° C. to 40° C. for no less than 48 hours, preferably at 20° C. to 25° C. for no less than 20 hours or at 30° C. to 40° C. for no less than 8 hours; or ii) cured at 60-80° C. for no less than 2 hours.

Preferably said primer in step a) after curing has a thickness of ≥0.1 mm to ≤2 mm, preferably ≥0.1 to ≤1 mm, more preferably ≥0.1 to ≤0.5 mm, and has a Shore D hardness of not less than 30, preferably not less than 50, more preferably not less than 70.

Preferably said primer in step a) after curing has an adhesion with the mold substrate of not less than 1.0 MPa, preferably not less than 2.5 MPa Preferably said primer in step a) after curing has a glass transition temperature of not less than 60° C.

Preferably said demolding layer in step b) is i) cured at 5° C. to 40° C. for not less than 60 hours, preferably at 20° C. to 25° C. for not less than 20 hours or at 30° C. to 40° C. for not less than 3 hours; or ii) at two stages including curing at 5° C. to 40° C. for not less than 2 hours, preferably at 20° C. to 25° C. for not less than 2 hours and further curing at 60° C. to 80° C. for not less than 2 hours.

Preferably said demolding layer in step b) after curing has a thickness of ≥0.1 mm to ≤2 mm, preferably ≥0.1 to ≤1 mm, more preferably ≥0.1 to ≤0.5 mm, and has a Shore D hardness of not less than 60, preferably not less than 70, and a contact angle of not less than 70°.

Preferably said demolding layer in step b) after curing has an adhesion to the surface of the primer layer of not less than 2.5 MPa.

Not being limited by the embodiments and descriptions, the invention provides a method of making molded concrete parts with smooth surface without requiring complex pre-treatment and post-treatment of the mold in each cycle. The concrete parts thus obtained also require less surface repair. Therefore, an increased production efficiency and reduced labor and material cost can be achieved.

According to one embodiment, therefore, the mold and the method of the invention are suitable for molding cement concrete with Portland cement as binder (OPC concrete). According to another embodiment, the mold and the method are suitable for demolding cement concrete with not only Portland cement, but also supplementary cementitious materials, such as microsilica, slags, fly ashes, clays, pozzolans or mixtures thereof as binder. According to yet another embodiment, the mold of the invention and the method is suitable for molding concrete with geopolymer as binder. In other words, this invention is suitable for concretes comprising cement in categories GEM I-V or geopolymer.

The present invention additionally provides for the use of the mold of the invention in making molded construction material products such as pre-cast concrete parts, cast concrete stones and the like.

Additional features and advantages of the invention will be more fully understood by considering the following description of examples thereof, taken in conjunction with the accompanying figures, in which:

FIG. 1 shows the demolding result of molded geopolymer concrete parts according to prior arts;

FIG. 2 shows the surface finish of molded OPC concrete parts according to comparative example;

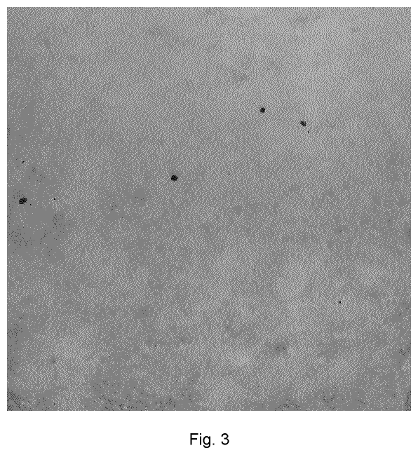

FIG. 3 shows the surface finish of molded OPC concrete parts according to the invention;

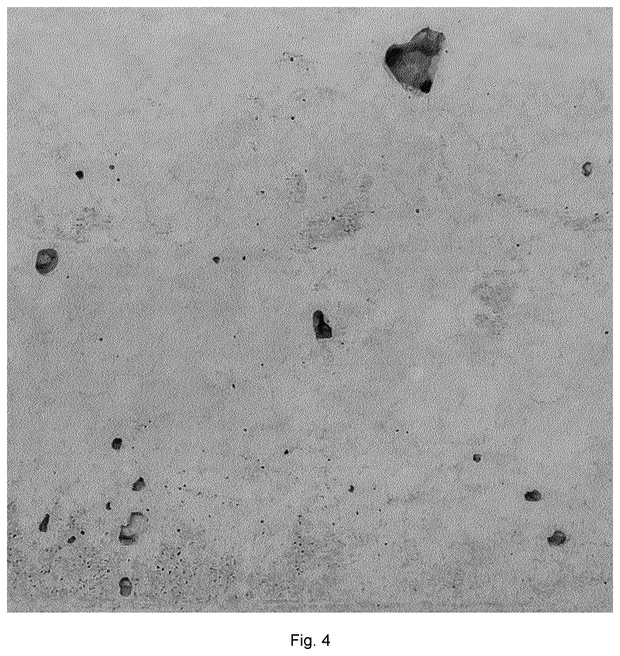

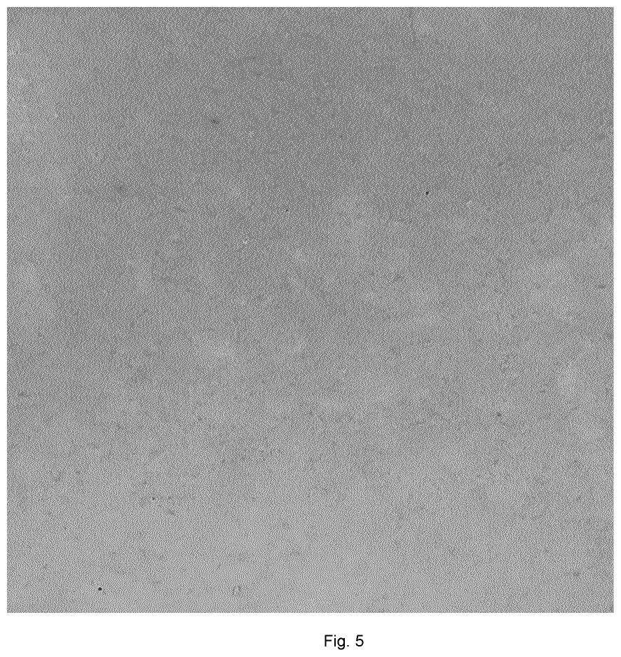

FIG. 4 shows the surface finish of molded geopolymer concrete parts according to comparative example;

FIG. 5 shows the surface finish of molded geopolymer concrete parts according to the invention.

### EXAMPLE

The present invention will now be described with reference to Examples and Comparative Examples, which are not intended to limit the scope of the present invention.

Materials and Devices

The following materials were used:

For primer:

Bisphenol A Epoxy Resin Araldite® GY 257 CI and amine-based curing agent Aradur® 450 BD were commercially available from Huntsman. Antirust filler aluminum triphosphate (CAS No. 13939-25-8), mica powder (CAS No. 12001-26-2), TiO₂ powder (CAS No. 13463-67-7), silane coupling agent KH-560 (CAS No. 2530-83-8) were used. Lucramul® WT 100 was purchased from Levaco Chemicals and used as wetting dispersant. BYK-410 was purchased from BYK and used as thickener. BYK-354 was used as defoamer. 2,4,6-Tris((dimethylamino)methyl)phenol (DMP-30, CAS No. 90-72-2) was used as the accelerating agent.

For demolding layer:

Arcol polyol 1104 was purchased from Covestro and used as the first polyhydroxy compound. Glycerin was used as the second polyhydroxy compound. 4,4′-diphenylmethane diisocyanate (MDI) with a functionality of 2.7 commercially available from BASF was used as polyisocyanate. Disperbyk® 199 was purchased from BYK and used as wetting dispersant. Calcium hydroxide CL-90S was used as metal component. BYK 088 was used as defoamer. Proviplast® 1783 from Pro-viron and Hexamoll® DINCH were used as plasticizer. Fumed silica was used as thickener.

A3 #(Q235 #) steel is provided by Shanghai Yihao Mechanical Equipment Co., Ltd. and used to assemble the mold. Manol Form Remover for metal mold ( [symbol] [symbol] )from Manol Co. Ltd. was used as the mineral oil type demolding agent in the comparative example.

The following devices were used:

IKA mixer was used for mixing the components. BINDER was used as the heating oven for curing. PosiTector 6000 was used to measure the thickness. HTS-610D was used to measure the hardness. Dataphysics OCA was used to measure the contact angle. Posited AT-A was used to measure the adhesion. DSC was used to measure the glass transition temperature.

Measurement Methods

(1) Contact Angle

Contact angle is measured by Dataphysics OCA. 5 points of the coating surface are tested to get an average value of the contact angle.

(2) Pull-off Adhesion

Pull-off adhesion is determined according to ASTM D4541 by Posited AT-A.

(3) Hardness

Hardness (Shored D) is determined according to DIN53505 and by HTS-610D. 5 points of the coating surface are tested to get an average value of the hardness.

(4) Glass Transition Temperature

Glass Transition Temperature is determined by DSC method.

(5) Percentage of Air Voids Area

Percentage of Air Voids Area is determined by image analysis software ImageJ according to the procedure described in Example 6.

(6) Thickness

Thickness is measured by PosiTector 6000. 12 points of the coating surface are tested to get an average value of the thickness.

### Example 1. Composition of Primer

According to the following general procedure, the composition as per Table 1 was prepared and later applied on the substrate of the mold.

In the respective blending proportions shown in Table 1, components of Component A and Component B were weighted and placed in a glass vessel and then mixed with an IKA mixer at speed of 1500 rpm for 1 min to obtain the primer.

TABLE 1
The components of primer in Example 1

| Component | Material | Dosage* (wt %) |
|---|---|---|
| Component A | Araldite GY 257 CI | 70 |
| | Aluminum triphosphate | 12 |
| | Mica powder | 12 |
| | TiO₂ powder | 5.96 |
| | Lucramul WT 100 | 0.01 |
| | KH-560 | 0.01 |
| | BYK-410 | 0.01 |
| | BYK-354 | 0.01 |
| Component B | Aradur 450 BD | 98 |
| | DMP-30 | 2 |

| | |
|---|---|
| Mix ratio (Component A:Component B) | 2:1 |

*based on the total weight of each component

It is understood that the primer provides sufficient bonding between the substrate and the demolding layer. It can also be used as an anti-corrosion coating on steel or metal substrate. The viscosity and rheology of the primer can be further adjusted by a thickener and a rheology modifier to accommodate different conditions of the mold, e.g. application on vertical planes of the mold.

### Example 2. Composition of Demolding Agent

According to the procedure in Example 1, the compositions as per Table 2 were prepared.

TABLE 2
The components of demolding agent in Example 2

| | | | Dosage* (wt %) | | |
|---|---|---|---|---|---|
| | | | Example | Example | Example |
| Component | Material | | 2A | 26 | 2C |
| Component | Deionized Water | | 15 | 15 | 15 |
| C | Arcol polyol 1104 | | 25 | 40 | 40 |
| | Glycerine | | 20 | 11 | 11 |
| | CL-90S | | 36 | 29.5 | 30 |
| | Disperbyk 199 | | 2 | 2 | 2 |
| | BYK 088 | | 2 | 2 | 2 |
| | Fumed silica | | — | 0.5 | — |
| Component | Polyisocyanate | MDI | 80 | — | — |
| D | | Prepolymer | | | |
| | | MDI | — | 80 | 80 |
| | | monomer | | | |
| | Plasticizer | Proviplast | 20 | 20 | — |
| | | 1783 | | | |
| | | Hexamoll ® | — | — | 20 |
| | | DINCH | | | |

| | | | |
|---|---|---|---|
| Mix ratio (Component C:Component D) | 30:70 | 44:56 | 44:56 |

*based on the total weight of each component

Monomer of 4,4′-diphenylmethane diisocyanate (MDI monomer) with NCO concentration of 31% was used in Example 21B-2C and liquid prepolymers of 4,4′-diphenylmethane diisocyanate with NCO concentration of 26% was used in Example 2A. MDI prepolymer was prepared by prepolymerization of MDI with polyol such as Castor oil.

The viscosity and rheology of the demolding layer can be adjusted by using a thickener and a rheology modifier to accommodate different conditions of the mold, e.g. application on vertical planes of the mold.

### Example 3. Preparation of the Mold

Three A3 #(Q235 #) steel plates with dimension 530 mm*150 mm*2 mm and two A3 #(Q235 #) steel plates with dimension 150 mm*150 mm*2 mm were used to form the mold. The steel plates are sanded to remove any stain, oil, oxides and other residue on the surface and cleaned with ethanol.

Proper amount of primer obtained according to Example 1 was brushed on the surface of five steel plates to form a layer of 0.2 mm. The plates with the primer are then placed in the oven at 23° C. for 24 hours.

After the primer is cured, proper amount of demolding agent obtained according to Example 2 was then brushed on top of the primer thus obtained to form a demolding layer of 0.2 mm. The five plates with the primer and the demolding layer are then placed in the oven for curing at 23° C. for 24 hours.

A steel frame with dimension 530 mm*150 mm*150 mm was used to assemble steel plates to from the mold. Buffer materials were applied at the back of the plates to secure the plates in place so that only the demolding layer faced the cavity to be filled with the concrete materials. The plates were stuck at the same position in every cycle. Same mold was used in each cycle throughout the experiment. The molds prepared with plates coated with primer according to Example 1 and demolding layer according to Example 2A-2C were named Example 3A-3C respectively.

The thickness, hardness, contact angle, adhesion, glass transition temperature of the plates was tested, and the results were summarized in Table 3.

TABLE 3
Characterization of the plates of the mold

| Layer | Example | 3A | 36 | 3C |
|---|---|---|---|---|
| Primer | Thickness (mm) | 0.2 | 0.2 | 0.2 |
| | Hardness (Shore D) | 94 | 94 | 94 |
| | Glass transition temperature | 81 | 81 | 81 |
| | (° C.) | | | |
| | Adhesion with steel plates | >2.5 | >2.5 | >2.5 |
| | (Mpa) | | | |
| Demolding | Thickness (mm) | 0.2 | 0.2 | 0.2 |
| layer | Contact angle (°) | 82 | 85 | 85 |
| | Hardness (Shore D) | 75 | 78 | 78 |
| | Adhesion with primer (Mpa) | >2.5 | >2.5 | >2.5 |

### Example 4. Composition of OPC Concrete

According to the following general procedure, the OPC concrete as per Table 4 were prepared.

Taiheiyo Cement having a density of 3.16 g/cm³ was used as cement. Oi river sand having size <5 mm and density of 2.58 g/cm³ was used as fine aggregate (sand). Oume crush stone having size of 5-20 mm and density of 2.65 g/cm³ was used as coarse aggregates (gravel).

The OPC concrete was mixed in a pan type mixer. Sand, gravel and cement were put into the mixer to form a sandwich of sand/gravel+cement+sand/gravel and pre-mixed for 10 seconds. Water and admixture (MG8000SS) were added and the concrete was mixed for 90 seconds to obtain a uniform mix.

TABLE 4
The components and properties of OPC concrete in Example 4

| | | Example 4A | Example 4B |
|---|---|---|---|
| Material | Water | 170 | 175 |
| (kg/m³) | Cement | 420 | 583 |
| | Sand | 839 | 789 |
| | Gravel | 933 | 808 |
| | Admixture | 3.36 | 5.25 |
| | (MG8000SS) | | |

| | | |
|---|---|---|
| Sand/(Sand + Gravel) (volume %) | 50 | 50 |
| Water/Cement (wt%) | 40.5 | 30 |
| Slump (cm) | 21 ± 2.5 | — |
| Flow (cm) | 35 ± 5 | 60 ± 5 |
| Air content % | 2 | 3 |

It's understood that water to cement ratio of 25-50% is preferred to obtain a OPC concrete with few air voids.

### Example 5. Composition of Geopolymer Concrete

According to the following general procedure, the geopolymer concrete as per Table 5 were prepared.

Blast furnace slag with a Blaine value of 4000 cm²/g and a density of 2.91 g/cm³, type F fly ash with 54.6% SiO₂ by weight and a density of 2.29 g/cm³, microsilica with 95.9% SiO₂ by weight and a specific surface ratio of 18.5 m²/g were used. The alkaline activator used was a 15% strength by weight aqueous NaOH and a 10% strength by weight aqueous KOH solution. R+D SPC 2017 from BASF was used as a dispersant.

TABLE 5
The components and properties of geopolymer concrete
in Example 5

| | | | Example 5A | Example 5B |
|---|---|---|---|---|
| Material | NaOH (15%) | | 180 | |
| (kg/m³) | KOH (10%) | | | 305 |
| | cementitious | Fly ash | 300 | 150 |
| | material | Slag | 150 | 400 |
| | | Microsilica | 50 | 30 |

| | | |
|---|---|---|
| R + D SPC 2017 | 20 | 10 |
| Sand | 800 | 800 |
| Gravel | 800 | 800 |

| | | |
|---|---|---|
| Sand/(Sand + Gravel) (volume %) | 50 | 50 |
| Water/cementitious material (wt %) | 29 | 45 |
| Flow (cm) | 55 ± 5 | 35 ± 5 |
| Air content % | 8 | 6 |

Geopolymer concrete was mixed in a pan type mixer. Sand, gravel, fly ash, slag, and microsilica were put into the mixer to form a sandwich of sand/gravel+fly ash/slag/microsilica+sand/gravel and pre-mixed for 20 seconds. Aqueous alkali activator solution and dispersant were added and the geopolymer concrete was mixed for 180 seconds to obtain a uniform mix.

It's understood that water to cementitious material ratio of 25-45% is preferred to obtain a geopolymer concrete suitable for curing and molding.

### Example 6. Curing and Demolding OPC Concrete Parts

After reaching the required slump, flow and air content value as mentioned in Table 4, the OPC concrete obtained in Example 4A was poured into the molds obtained according to Example 3A-3C from center to side. OPC concrete was poured in two layers. Each layer being internally vibrated in four equidistant spots with high speed for 10 seconds per spot in each layer.

The molds were then covered with plastic wrap and placed in 23° C. for the OPC concrete to rest. After 2 hours of rest, the mold with concrete was placed into the BINDER chamber and cured according to the following temperature schedule for 22 hours.

Schedule 1. Increase the temperature from 20° C. to 50° C. in 2 hours;

Schedule 2. Keep the temperature at 50° C. for 3 hours;

Schedule 3. Decrease the temperature from 50° C. to 20° C. in 3 hours;

Schedule 4. Keep the temperature at 20° C. for 14 hours.

Demolding was carried out immediately after curing. Each plate was removed from the frame and the molded OPC concrete parts were demolded. The plates were then held under tap water to remove the loosely held particles. Strongly attached mortar particles were removed with the edge of a soft brush, if there is any. After all visible mortar particles were removed, the plates were wiped with a wet cloth followed by wiping with a dry cloth. This would make the plates ready for the next cycle. The molded concrete parts obtained by using mold according to Example 3A-3C were named Example 6A-6C respectively.

The plates were put back into the frame to repeat the above steps for a total of 30 cycles for Example 6A and 6C and 50 cycles for Example 6B. The plates were stuck at the same position in every cycle.

### Example 7. Curing and Demolding Geopolymer Concrete Parts

After reaching the required flow and air content value as mentioned in Table 5, the geopolymer concrete obtained in Example 5A was poured into the mold obtained according to Example 3B from center to side. Geopolymer concrete was poured in two layers. Each layer being internally vibrated in four equidistant spots with high speed for 10 seconds per spot in each layer.

The molds were then covered with plastic wrap and placed in 20° C. for the geopolymer concrete to rest and cure for 24 hours.

Demolding was carried out immediately after curing. Each plate was removed from the frame and the molded geopolymer concrete parts were demolded. The plates were then held under tap water to remove the loosely held particles. Strongly attached mortar particles were removed with a soft brush, if there is any. After all visible mortar particles were removed, the plates were wiped with a wet cloth followed by wiping with a dry cloth. This would make the plates ready for the next cycle. The plates were put back into the frame to repeat the above steps for a total of 10 cycles for Example 7. The plates were stuck at the same position in every cycle.

### Comparative Example 1

The same steel plates and frame before coating as in Example 3 were used to form the mold. The steel plates were sanded to remove any stain, oil, oxides and other residue on the surface and cleaned with ethanol.

Mineral oil was uniformly brushed on the surface of the steel plates as demolding agent. According to the procedure in Example 6, the OPC concrete was cured and demolded except that mineral oil was coated on the substrate instead of multiple resin-based layers comprising primer and demolding layer. Care was taken to avoid pulling off oil from the mold, which leads to poor concrete surface.

### Comparative Example 2

The same procedure as in Comparative Example 1 was used except that the geopolymer prepared according to Example 5 was cured and demolded by using mineral oil as the demolding agent.

### Example 8. Image Analysis of Concrete Surface

The surface of cured concrete parts was firstly pressed gently with fingers to ensure that all hidden voids or bubbles on the surface were exposed. Then the images of surface of the concrete parts obtained in each cycle were taken and analyzed.

ImageJ software was used to visualize the distribution of air voids and to quantify the percentage of air voids area on the concrete surface as follows:

1. Drag and open the image to be analyzed into ImageJ software;

2. Select predetermined area to be analyze, crop it out, and set appropriate scale (e.g. 125×125 mm);

3. Adjust brightness and contrast of the image until only air voids are seen, then click “apply”;

4. Adjust the threshold to such a value that all air voids can be observed, then click “apply”;

5. Use the analyze tab to analyze the air voids, obtain the output of air voids area distribution, percentage of total air voids area based on total area of concrete surface and count of air voids.

The calculated percentage of air voids area by image analysis of Example 6A-6C, Example 7 and Comparative Example 1-2 were summarized in Table 6.

TABLE 6
Percentage of air voids area (%)

| | Example | | | | | |
|---|---|---|---|---|---|---|
| | | | | | Comparative | Comparative |
| Cycle | 6A | 6B | 6C | 7 | Example 1 | Example 2 |
| Average (%) | 0.42 | 0.33 | 0.33 | 0.29 | 0.92 | 1.05 |
| 1 | 0.36 | 0.38 | 0.40 | 0.45 | 0.59 | 1.03 |
| 2 | 0.29 | 0.45 | 0.31 | 0.72 | 0.51 | 2.16 |
| 3 | 0.20 | 0.45 | 0.28 | 0.62 | 0.81 | 1.22 |
| 4 | 0.35 | 0.25 | 0.31 | 0.43 | 0.54 | 0.56 |
| 5 | 0.37 | 0.35 | 0.36 | 0.11 | 1.28 | 0.68 |
| 6 | 0.51 | 0.40 | 0.23 | 0.18 | 0.98 | 0.86 |
| 7 | 0.41 | 0.49 | 0.40 | 0.21 | 0.90 | 1.33 |
| 8 | 0.44 | 0.55 | 0.48 | 0.08 | 0.75 | 1.09 |
| 9 | 0.31 | 0.40 | 0.39 | 0.05 | 0.65 | 1.13 |
| 10 | 0.52 | 0.38 | 0.37 | 0.01 | 1.74 | 0.43 |
| 11 | 0.78 | 0.55 | 0.40 | — | 1.78 | — |
| 12 | 0.40 | 0.26 | 0.30 | — | 0.95 | — |
| 13 | 0.29 | 0.25 | 0.32 | — | 0.96 | — |
| 14 | 0.22 | 0.25 | 0.26 | — | 0.97 | — |
| 15 | 0.27 | 0.46 | 0.31 | — | 0.57 | — |
| 16 | 0.54 | 0.30 | 0.31 | — | 0.88 | — |
| 17 | 0.52 | 0.25 | 0.32 | — | 0.76 | — |
| 18 | 0.63 | 0.36 | 0.37 | — | 1.42 | — |
| 19 | 0.36 | 0.26 | 0.37 | — | 0.67 | — |
| 20 | 0.27 | 0.25 | 0.29 | — | 0.95 | — |
| 21 | 0.40 | 0.30 | 0.32 | — | 0.44 | — |
| 22 | 0.34 | 0.19 | 0.34 | — | 0.99 | — |
| 23 | 0.53 | 0.26 | 0.40 | — | 1.18 | — |
| 24 | 0.47 | 0.24 | 0.17 | — | 0.63 | — |
| 25 | 0.60 | 0.26 | 0.27 | — | 1.26 | — |
| 26 | 0.32 | 0.20 | 0.48 | — | 0.62 | — |
| 27 | 0.62 | 0.33 | 0.17 | — | 0.56 | — |
| 28 | 0.53 | 0.33 | 0.26 | — | 0.74 | — |
| 29 | 0.24 | 0.21 | 0.25 | — | 0.98 | — |
| 30 | 0.36 | 0.17 | 0.31 | — | 0.66 | — |
| 31 | — | 0.57 | — | — | 1.11 | — |
| 32 | — | 0.12 | — | — | 0.82 | — |
| 33 | — | 0.43 | — | — | 1.72 | — |
| 34 | — | 0.44 | — | — | 1.09 | — |
| 35 | — | 0.29 | — | — | 1.72 | — |
| 36 | — | 0.39 | — | — | 1.02 | — |
| 37 | — | 0.36 | — | — | 0.52 | — |
| 38 | — | 0.28 | — | — | 0.69 | — |
| 39 | — | 0.18 | — | — | 0.99 | — |
| 40 | — | 0.28 | — | — | 0.68 | — |
| 41 | — | 0.39 | — | — | 0.66 | — |
| 42 | — | 0.23 | — | — | 0.71 | — |
| 43 | — | 0.18 | — | — | 0.71 | — |
| 44 | — | 0.56 | — | — | 0.73 | — |
| 45 | — | 0.33 | — | — | 1.19 | — |
| 46 | — | 0.36 | — | — | 0.88 | — |
| 47 | — | 0.36 | — | — | 1.19 | — |
| 48 | — | 0.20 | — | — | 0.88 | — |
| 49 | — | 0.42 | — | — | 1.40 | — |
| 50 | — | 0.36 | — | — | 0.81 | — |

It's shown in Table 6 that the result of concrete surface according to Example 6A-6C, Example 7 have small air voids area percentage throughout the cycles, which is much lower than that of Comparative Example 1-2 in each corresponding cycle.

FIG. 2 shows the image of the molded OPC concrete surface obtained according to Comparative Example 1 and FIG. 3 shows the image of the molded OPC concrete surface obtained according to Example 6B after 10′^{h} cycle. It is obvious that many air voids can be found on the surface of Comparative Example 1 while molded concrete in Example 6B has a better surface finish with fewer and smaller air voids on concrete surface.

Similarly, FIG. 4 shows the image of the molded geopolymer concrete surface obtained according to Comparative Example 2 and FIG. 5 shows the image of the molded geopolymer concrete surface obtained according to Example 7 after 10^{th} cycle. It is obvious that many air voids can be found on the surface of Comparative Example 2 while molded concrete in Example 7 has a better surface finish with fewer and smaller air voids on concrete surface. Very few residuals of geopolymer concrete was left on the mold after each cycle. The mold didn't need additional maintenance or cleaning process after each cycle. In comparison, cleaning mold in Comparative Example 2 was more difficult than mold in Example 7. Geopolymer mortar was strongly attached to mold surface and had to be scraped out.

The above results demonstrate that the concrete parts obtained according to the invention have better surface finish than Comparative Examples throughout the cycles even though the application method, person of application and all other variables are held constant. The results also prove that the multiple resin-based layers comprising of primer and demolding layer can adhere strongly to the substrate and produces satisfactory results after 10, 30 or even 50 cycles.

It is advantageous that the concrete parts obtained according to the invention have lower value of percentage of air voids area and hence smooth surface com-pared with that of Comparative Examples when mineral oil is used as the demolding agent. The above results indicate that the method of the invention successfully produce concrete parts with improved surface finish without preparing the mold in each cycle. The results also showed that the mold according to the present invention can be used for multiple cycles and can be used to product concrete parts with improved surface finish, even after multiple cycles.

### Comparative Example 3

Demolding agent obtained according to Example 2 was brushed on the steel plates to form a demolding layer of 0.2 mm without primer. According to the procedure in Example 6, the OPC concrete was cured and demolded with the exception that the plates without primer thus obtained were used.

After 3-5 cycles, it was discovered that the demolding layer was partially peeled off from the substrate and the OPC concrete surface obtained after 3-5 cycles no longer had smooth surface desired by the inventors. Therefore, it is essential to have primer between the substrate and the demolding layer to guarantee a consistent and durable performance of the mold coated with multiple resin-based layers according to the invention.

### Example 9

The OPC concrete parts were cured and demolded by the same process according to Example 6B except that the demolding layer was cured in a two-stage process: (1) put the plates into an oven at 23° C. for 2 hours; then (2) put the plates into an oven at 70° C. for 2 hours.

Average percentage of air voids area of concrete surface obtained according to Example 9 for 10 cycles is 0.09%, showing a satisfactory smooth surface.

### Example 10

The concrete parts were cured and demolded by the same process according to Example 6B except that plates made of steel, aluminum, plywood and PVC resin are individually used as plates of the mold. The pull-off adhesion between multiple resin-based layers comprising primer and demolding layer and each substrate was tested and summarized in Table 7.

TABLE 7
Pull-off adhesion between multiple resin-based layers
and substrates in Example 10

| | Example | Example | Example | Example |
|---|---|---|---|---|
| | 10A | 10B | 10C | 10D |
| Plate | steel | aluminum | plywood | PVC |
| material | | | | |
| Pull-off | >2.5 | >1.7 | >1.4 | No value* |
| adhesion | | | | |
| (Mpa) | | | | |
| Point of | between | between | inside the | — |
| failure | demolding | demolding | wood | |
| | layer and | layer and | material | |
| | dolly | dolly | | |

*the adhesion is too weak to be measured

### Example 11

The OPC concrete parts were cured and demolded by the same process according to Example 6A-B except that the primer and demolding layer were applied and cured at different temperatures. The curing time was summarized in Table 8.

TABLE 8
Curing time of primer and demolding layer in Example 11

| | | Demolding | Demolding |
|---|---|---|---|
| | Primer | layer | layer |
| | Example 1 | Example 2A | Example 2B |
| 5° C. (hours) | 48 | 60 | 60 |
| 40° C. (hours) | 8.4 | 3.2 | 2.4 |
| 70° C. (hours) | 2 | — | — |

The structures, materials, compositions, and methods described herein are intended to be representative examples of the invention, and it will be understood that the scope of the invention is not limited by the scope of the examples. Those skilled in the art will recognize that the invention may be practiced with variations on the disclosed structures, materials, compositions, and methods, and such variations are regarded as within the ambit of the invention. Thus, it is intended that the present invention cover such modifications and variations as come within the scope of the appended claims and their equivalents. The mold and the method of preparing molded parts according to the present invention are therefore not limited to concrete or construction materials as described herein. Those skilled in the art will recognize that the invention may be applicable to a demolding process of a similar nature as described in the invention.

1. A mold for molding construction materials characterized in that the mold is coated with multiple resin-based layers comprising at least a first epoxy resin-based primer layer and a second polyurethane resin-based demolding layer.

2. The mold according to claim 1, wherein said demolding layer is coated on top of the primer layer.

3. The mold according to claim 1, wherein said epoxy resin-based primer layer contains the reaction product from a composition comprising bisphenol A epoxy resin, at least one amine-based curing agent, at least one accelerating agent and optional additives selected from the group consisting of anti-rust fillers, mica powder, pigments, defoamers, wetting dispersants, coupling agents, thickening agents and any mixture thereof.

4. The mold according to claim 3, wherein said epoxy resin-based primer layer contains the reaction product from a two-component composition comprising:
(I) Component A comprising ≥50 wt. % to ≤100 wt. % by weight of Component A of bisphenol A epoxy resin; and
(II) Component B comprising:
(i) ≥90 wt. % to ≤99 wt. % by weight of Component B of at least one amine-based curing agent; and
(ii) ≥1 wt. % to ≤10 wt. % by weight of Component B of at least one accelerating agent,
wherein the weight ratio of Component A to Component B is in the range of 10:1 to 10:9.

5. The mold according to claim 2, wherein said polyurethane resin-based demolding layer contains the reaction product from a composition comprising polyol, water, polyisocyanate, metal component, and optional additives selected from the group consisting of fillers, dispersants, plasticizers, defoamers, wetting dispersants, thickening agents and any mixture thereof.

6. The mold according to claim 5, wherein said polyurethane resin-based demolding layer contains the reaction product from a two-component composition comprising:
(I) Component C comprising:
(i) ≥0.2 wt. % to ≤40 wt. % of a first saturated polyhydroxy compound based on the total weight of the two-component composition selected from the group consisting of polyether polyol, polyester polyol, C2 to C32 alkyl polyol and sugar alcohol;
(ii) ≥1 wt. % to ≤50 wt. % of water based on the total weight of the two-component composition; and
(iii) ≥2 wt. % to ≤50 wt. % of at least one metal component selected from the group consisting of metal oxide, metal hydroxide, metal aluminate and metal silicate, by weight of the total weight of the two-component composition; and
(II) Component D comprising at least one polyisocyanate.

7. The mold according to claim 6, wherein Component C further comprises ≥0.2 wt. % to ≤20 wt. % by weight of the total weight of the two-component composition of a second saturated polyhydroxy compound selected from the group consisting of polyether polyol, polyester polyol, C2 to C32 alkyl polyol and sugar alcohol, wherein the second saturated polyhydroxy compound is different from the first saturated polyhydroxy compound.

8. The mold according to claim 7, wherein the first saturated polyhydroxy compound has a weight average molecular weight Mw in the range of ≥100 to ≤20,000 g/mol and the second polyhydroxy compound has a weight average molecular weight Mw in the range of ≥50 to ≤2,000 g/mol.

9. The mold according to claim 5, wherein the at least one polyisocyanate in Component D is a liquid oligomer or prepolymer.

10. The mold according to claim 5, wherein the at least one polyisocyanate in Component D is selected from the group consisting of pentamethylene diisocyanate, hexamethylene diisocyanate, isophorone diisocyanate, 2,2,4- and 2,4,4,-trimethyl-1,6-hexamethylene diisocyanate, tetramethoxybutane 1,4-diisocyanate, butane-1,4-diisocyanate, dicyclohexylmethane diisocyanate, cyclo-hexane 1,3- and 1,4-diisocyanate, 1,12-dodecamethylene diisocyanate, diisocyanates of dimeric fatty acids, lysine methyl ester diisocyanate, 1-isocyanato-3,3,5-trimethyl-5-isocyanatomethylcyclohexane, hydrogenated diphenylmethane diisocyanate, hydrogenated 2,4-tolyene diisocyanate, hydrogenated 2,6-tolylene diisocyanate, methylene diphenyl diisocyanate, toluene diisocyanate, naphthalene diisocyanate, polymeric methylene diphenyl diisocyanate, and carbodiimide-modified methylene diphenyl diisocyanate.

11. The mold according to claim 6, wherein the amount of the at least one polyisocyanate in Component D is in the range of ≥10 wt. % to ≤90 wt. % based on the total weight of the two-component composition.

12. The mold according to claim 1, wherein said mold is made of metal or plywood and/or have metal or plywood contacting surface, preferably said mold is made of steel, aluminum or plywood and/or has steel, aluminum or plywood contacting surface.

13. The mold according to claim 1, wherein said primer layer has a thickness selected from ≥0.1 mm to ≤2 mm, or ≥0.1 to ≤1 mm, or ≥0.1 to ≤0.5 mm.

14. The mold according to claim 1, said primer layer has a Shore D hardness of not less than 30, or not less than 50, or not less than 70.

15. The mold according to claim 1, wherein said primer layer has an adhesion with the mold substrate of not less than 1.0 MPa, or not less than 2.5 MPa.

16. The mold according to claim 1, wherein said primer layer has a glass transition temperature of not less than 60° C.

17. The mold according to claim 1, wherein said demolding layer has a thickness of 0.1 mm to 2 mm, or 0.1 to 1 mm, or 0.1 to 0.5 mm.

18. The mold according to claim 1, wherein said demolding layer has a Shore D hardness of not less than 60, or not less than 70.

19. The mold according to claim 1, wherein said demolding layer has a contact angle of not less than 70°.

20. The mold according to claim 2, wherein said demolding layer has an adhesion to the surface of the primer layer of not less than 2.5 MPa.

21. A method for making molded construction materials, comprising the steps of:
(I) adding construction materials into a mold according to claim 1;
(II) curing the construction materials to form cured parts of construction materials; and
(III) demolding the cured parts of construction materials from the mold.

22. The method according to claim 21, wherein step I) to III) are repeated for not less than twice.

23. The method according to claim 22, wherein step I) to III) are repeated for not less than 10 times, or more than 20 times, or more than 30 times, or more than 50 times.

24. The method according to claim 21, wherein said construction material is a concrete comprising cementitious material, aggregates, and water, wherein the weight ratio between water to cementitious material is in the range of ≥0.25 to ≤0.50, or ≥0.27 to ≤0.45, or ≥0.3 to ≤0.45.

25. The method according to claim 24, wherein said cementitious material is CEM I-V cement or geopolymer raw material.

26. Cured parts of construction material obtained from the method according to claim 1.

27. The cured parts of construction material according to claim 26, wherein the construction material is concrete and the percentage of total air voids area on the surface of the cured concrete part is not more than 0.9%, or not more than 0.8%, or not more than 0.6%, or not more than 0.5% based on the total surface area of the cured concrete part.
